(19) United States
(12) Patent Application Publication
(10) Pub. No.: US 2014/0070614 A1
(43) Pub. Date: Mar. 13, 2014

(54) Household Grid-Connected Inverter Applied to Solar Power Generation System with Maximum Power Tracking Function

(71) Applicants: Kuo-Yuan Lo, Taoyuan County (TW); Yung-Ruei Chang, Taoyuan County (TW); Yaow-Ming Chen, Taipei City (TW)

(72) Inventors: Kuo-Yuan Lo, Taoyuan County (TW); Yung-Ruei Chang, Taoyuan County (TW); Yaow-Ming Chen, Taipei City (TW)

(73) Assignee: ATOMIC ENERGY COUNCIL-INSTITUTE OF NUCLEAR ENERGY RESEARCH, Taoyuan County (TW)

(21) Appl. No.: 13/607,044

(22) Filed: Sep. 7, 2012

(51) Int. Cl. H02M 7/537

(52) U.S. Cl. 307/43; 363/131

(57) ABSTRACT

A household Grid-Connected inverter applied to a solar power generation system with maximum power tracking function includes a solar power module; a MPPT power converter connected to the solar power module; and a DC/AC filter connected to the MPPT power converter. The DC/AC filter can be connected to the household grid in parallel. The solar power module is used to convert and output the solar energy in form of DC voltage. The MPPT power converter converts the DC into a high-frequency current with envelope of the same phase as the household grid, and also maximizes the output power. The DC/AC filter is used to output to the current which has the same phase as the household power and of the wave current form. Thereby, a simplified structure which can increase the device expanding flexibility and provide maximum output performance for solar power generation is achieved with lower cost.

### BACKGROUND OF THE INVENTION

1. Field of the Invention

The present invention relates to a household power parallel converter applied to a solar power generation system with maximum power tracking function. More particularly the present invention relates to a household power parallel converter and a DC/AC filter can be connected to the grid with a simplified structure, which can increase the device expanding flexibility, have the maximum output performance for solar power generation and can be achieved with lower cost.

2. Description of Related Art

Solar energy is one of the currently most potential renewable energy recourses. In recent years, government has been actively promoting the development of renewable energies. The solar energy therefore becomes the fastest growing and most stable energy in the recent market, and also the sustainable energy project the government has been actively developed in recent years. The domestic manufacturers thus have begun competing the solar photovoltaic relevant market. Ministry of Economic Affairs has set its promoting goal, the amount of up to 2500 MW until 2030.

Traditional solar modules are connected in series in order to have enough voltage for use. However the connection in series tends to reduce the solar power generation efficiency because the shielding effect, the dust accumulation and the aging of solar modules and uneven process features. Modular and small solar energy systems have gradually drawn attention, and are easy to install in residential areas and industrial parks due to local conditions and decentralized regulation characteristics.

Natural disasters such as earthquakes and tsunamis also contribute to the rising sound of demand of renewable energy inside the country and overseas. The purchase rate of a solar photoelectric roof is NT$7.33 to NT$10.32/kWh which is highly attractive to the industry. The present invention proposes a circuit of modular architecture, which can reduce costs and expand the existing technology so as to increase the application of a variety of renewable energies.

In the conventional architectures, such as the ROC Patent No. I328730 entitled “a maximum power tracking system for a solar power generation system and a device thereof”, a maximum power is used to track the maximum power for a circuit. It requires an additional current detector to finish the calculation of the input power. Such a method costs high and has no modular parallel features. It does not satisfy the expectation for the cost-benefit analysis of the solar power system. It does not favor the promotion of solar power generation applications either.

ROC Patent Publication No. 201037958, entitled “high-performance solar energy system”, discloses that by adjusting a modular DC/DC converter along with a converter to realize a solar power generation system. The modular converter is integrated with the maximum power tracking feature. Even though it can improve the problem of reduced efficiency of the solar modules in series, the cost of circuit elements still increases and the two-stage high frequency switching design will adversely affects the overall circuit efficiency, both being obstacles for the practical application of solar power.

U.S. Patent Publication No. 20090284998 “Method and system for providing maximum power point of tracking in an energy generation system” discloses the use of communication interfaces and digital-analog conversion to control the tracking of the maximum power point, and the need of extra voltage/current detector to achieve the maximum power for capturing renewable energy. The high-cost and complex or digitized controller required in the above patent is neither cost-effective in the solar system nor favorable to applications to the promotion of renewable energy.

U.S. Patent Publication No. 20100123428 “Battery-Charging Device for a Stand-Alone the Generator the System having a MPPT the Function and Method Thereof” discloses a simple architecture which need to detect the output voltage and current and calculate the power to track the maximum power. The calculated power determines the current value needed for battery charging. Furthermore, its cost is still high, which is not cost-effective in the solar system and not conducive to the promotion of renewable energy either.

U.S. Pat. No. 7,492,162 “Inverter system” discloses an architecture which still needs to detect the output voltage and current and calculate the power to achieve the tracking of the maximum power point, and also needs to determines current information in a battery-sense way. Output short circuit protection function can be sensed by the change of magnetic field. Even though it can be applied to the solar system, its cost is still high which is not cost-effective in the solar system and not conducive to the promotion of renewable energy either.

The inventors have made long-term efforts in solving such a problem, and successfully got an approach to achieve a household power parallel converter applied to a solar power generation system with maximum power tracking effect, which can overcome the problem encountered in the prior art.

### SUMMARY OF THE INVENTION

A main purpose of this invention is to improve the power conversion efficiency, increase the overall PV array output power, reduce the output inductor size, eliminate the input current sensor, and simplify the control circuit. The household power parallel converter converts the solar power into high-frequency current pockets which have the same phase as the voltage of household grid and also to maximize the output power. The DC/AC filter converts high-frequency current into a sinusoidal one with the grid frequency. Such a household Grid-connected inverter with a simplified structure can increase the device expanding flexibility, has the maximum output performance for solar power generation and can be achieved with lowered cost.

In order to achieve the above and other objectives, the household power parallel converter applied to a solar power generation system with maximum power tracking function includes a solar power module; a MPPT power converter connected to the solar power module; and a DC/AC filter connected to the MPPT power converter.

In one embodiment of the invention, the solar power module includes a majority of solar panels connected to one another in parallel.

In one embodiment of the invention, the MPPT power converter includes a capacitor connected to the solar power module, a switching element connected to the capacitor, a MPPT controller connected to the capacitor and the switching element, an inductor connected to the switching element and the inductor, and a diode connected to the inductor.

In one embodiment of the invention, the DC/AC filter includes a capacitor connected to the MPPT power converter, first, second, third and fourth switches respectively connected to the capacitor, and an inductor connected to the first, second, third and fourth switches.

In one embodiment of the invention, the first, second, third and fourth switches are connected to one another.

In one embodiment of the invention, the first, second, third and fourth switches are low-frequency switches.

### BRIEF DESCRIPTION OF THE DRAWINGS

FIG. 1 is a schematic view of a block diagram according to a first embodiment of the invention.

FIG. 2 is a schematic view of use status according to a first embodiment of the invention.

FIG. 3 is a schematic view of control signal generation according to a first embodiment of the invention.

FIG. 4 is a schematic view of input inductor current waveform according to a first embodiment of the invention.

FIG. 5 is a schematic view of use status according to a second embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

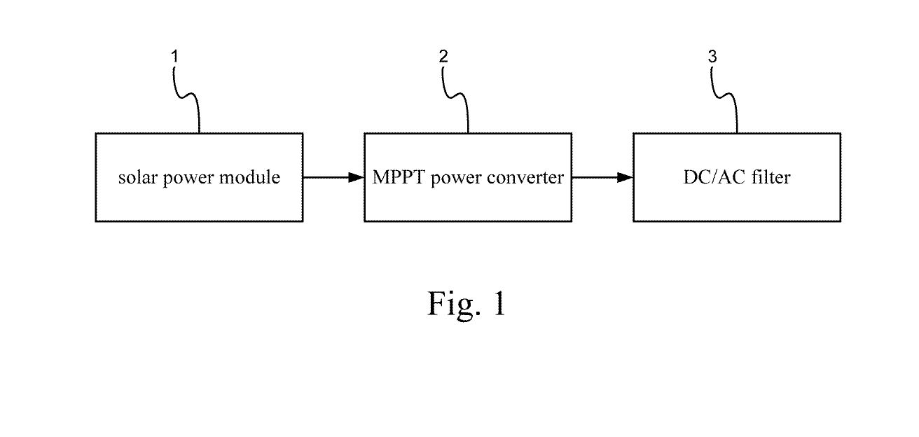

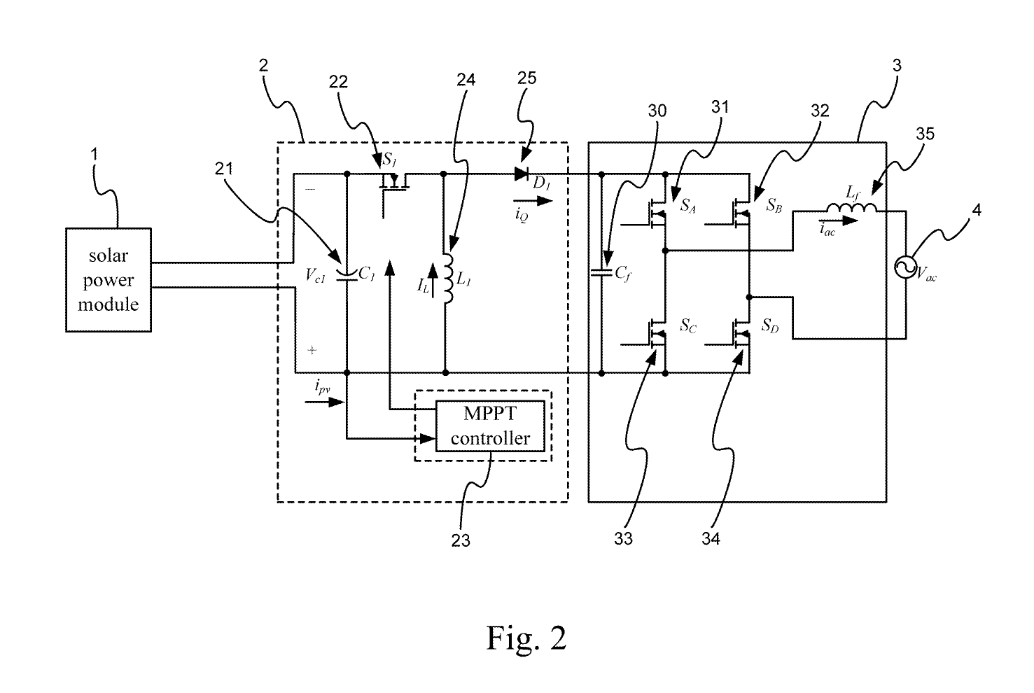

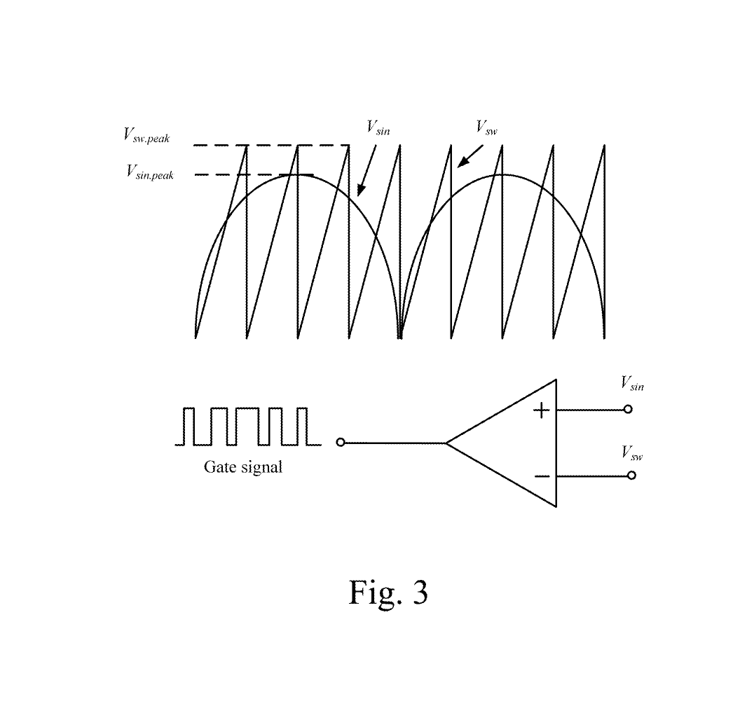

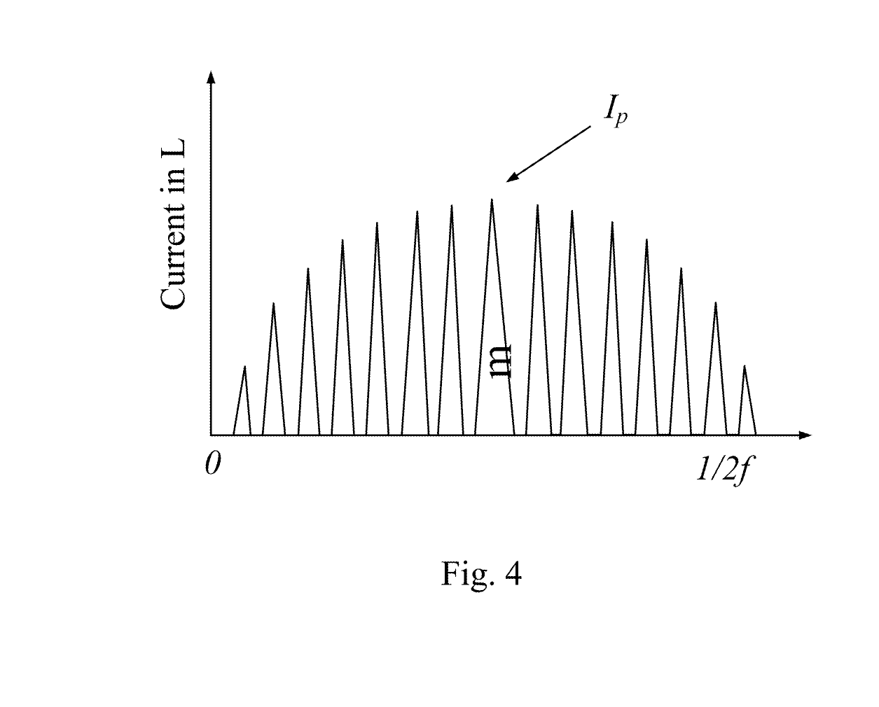

FIG. 1 is a schematic view of a block diagram according to a first embodiment of the invention. FIG. 2 is a schematic view of use status according to a first embodiment of the invention. FIG. 3 is a schematic view of control signal generation according to a first embodiment of the invention. FIG. 4 is a schematic view of input inductor current waveform according to a first embodiment of the invention. As shown, a household power parallel converter which is applied to a solar power generation system with maximum power tracking function according to the invention at least includes a solar power module 1, an MPPT power converter 2 and a DC/AC filter 3.

The solar power module 1 contains a majority of mutually parallel solar panels, and uses photovoltaic modules to convert solar energy into electrical energy. The electric power is output in the form of DC voltage.

The MPPT power converter 2 is connected to the solar power module 1, and contains a capacitor 21 connected to the solar power module 1, a switching element 22 connected to the capacitor 21, a MPPT controller 23 connected to the capacitor 21 and the switching element 22, an inductor 24 connected to the switching element 22 and the inductor 24, and a diode 25 connected to the inductor 24. The MPPT power converter 2 converts the direct current output from the solar power module 1 into the current which is the same with a household power 4, and has a McDonald's packet of high frequency current. Meanwhile taking advantage of the MPPT controller 23 to calculate and control the switching element 22, the output power is controlled to the maximum.

The DC/AC filter 3 is connected to the MPPT power converter 2, and contains a capacitor 30 connected diode 25, four switches (first, second, third and fourth switches 31, 32, 33, 34) connected to the capacitor 30, and an inductor 35 connected to the first, second, third and fourth switches 31,32,33,34. The first, second, third and fourth switches 31,32,33,34 are low-frequency switches connected to one another. The DC/AC filter 3 receives the current which is the same with a household power 4, and has a McDonald's packet of high frequency the current which is the same with a household power 4, and has a McDonald's packet of high frequency current. The current is converted into alternating current through the first, second, third and fourth switches 31, 32, 33, 34. There after being filtered through the capacitor 30 and the inductor 35, a current which has the same voltage with the household power 4 and is in form of wave current is output to the household power 4. Thereby, a novel household parallel converter applied to the solar power generation system with maximum power tracking.

When the present invention is in operation at a discontinuous current mode, the switching element 22 switches to control the inductor 24 for energy storage. Then through the diode 25 a pulse current of rectified sinusoidal type packet is output to pass through the capacitor 30, the inductor 35. The first, second, third and fourth switches 31,32,33,34 switch the current to low frequency sinusoidal current to output to the household power 4.

As shown in FIG. 3, with the use of a rectified household power low-frequency sinusoidal signal and a sawtooth wave, compare a sinusoidal pulse width modulation (SPWM) control signal output to the switching element 22. From FIG. 4, it is apparent that the control signal is used to form an inductor current waveform having characteristics of the sinusoidal type packet. In order to operate the present invention at the discontinuous current mode, the maximum conduction rate, input voltage and output voltage shall comply with the following formula:

$${D}_{p} ( 1 + \frac{{V}_{c 1}}{\sqrt{2} {V}_{ac}} ) < 1$$

In FIG. 1, if the circuit is operating at the continuous current mode, the input power can be approximated to the one for input inductance, and can be expressed as:

$${P}_{L} = \frac{1}{2} {L}_{m} {f}_{s} Δ {I}_{L}^{2}$$

where Lₘ is the input inductance, fₛ, is the frequency of circuit switching, ΔI_{L} is the average change for each switching cycle of the inductor current. From FIG. 4, ΔI_{L} can be expressed as:

$$Δ {I}_{L} = \frac{2 f}{{f}_{s}} {\sum }_{k = 1}^{N} ( {I}_{p} \cdot sin ( \frac{k π}{N} ) )$$

where f is the frequency of the household power, N is the number of switching the switch S1 for each household power cycle, I_{P} is the peak current for each household power cycle. Therefore, the circuit input power can be expressed as:

$${P}_{L} = {fL}_{m} {\sum }_{k = 1}^{N} {( {I}_{p} \cdot sin ( \frac{k π}{N} ) )}^{2}$$

wherein the peak current I_{P} can be expressed as:

$${I}_{p} = \frac{{V}_{c 1}}{{L}_{m} {f}_{s}} \cdot {D}_{p}$$

where D_{P} is the pulse modulation control signal of the maximum conduction rate, V_{c}^{j}, is an input voltage. The last input power can be expressed as:

$${P}_{L} = \frac{f}{{L}_{m} {f}_{s}^{2}} {\sum }_{k = 1}^{N} {( {V}_{c 1} {D}_{p} \cdot sin ( \frac{k π}{N} ) )}^{2}$$

The above the input power includes the equation of the input voltage and maximum conduction rate. If the input inductance and switching frequency are used in the circuit design, the input power can be obtained from the input voltage and the maximum conduction rate. Compared to a conventional way to obtain the input power by multiplying the input voltage by the input current, the present invention does not need the input current for obtaining the input power when in achieving the maximum power tracking. This can save the cost of the input current sensors, and significantly save the cost for modular solar power converter. The invention offers at least the following advantages:

1. Simplification of circuit architecture for the maximum power capturing control.

2. The circuit architecture is for single-stage design, reducing the use of circuit elements and relevant cost while increasing the overall circuit efficiency.

3. No need for complex current sensing components, reducing costs while increasing reliability.

4. Modular design for circuits, increasing the device expanding flexibility and improving the shortcomings of solar modules in series.

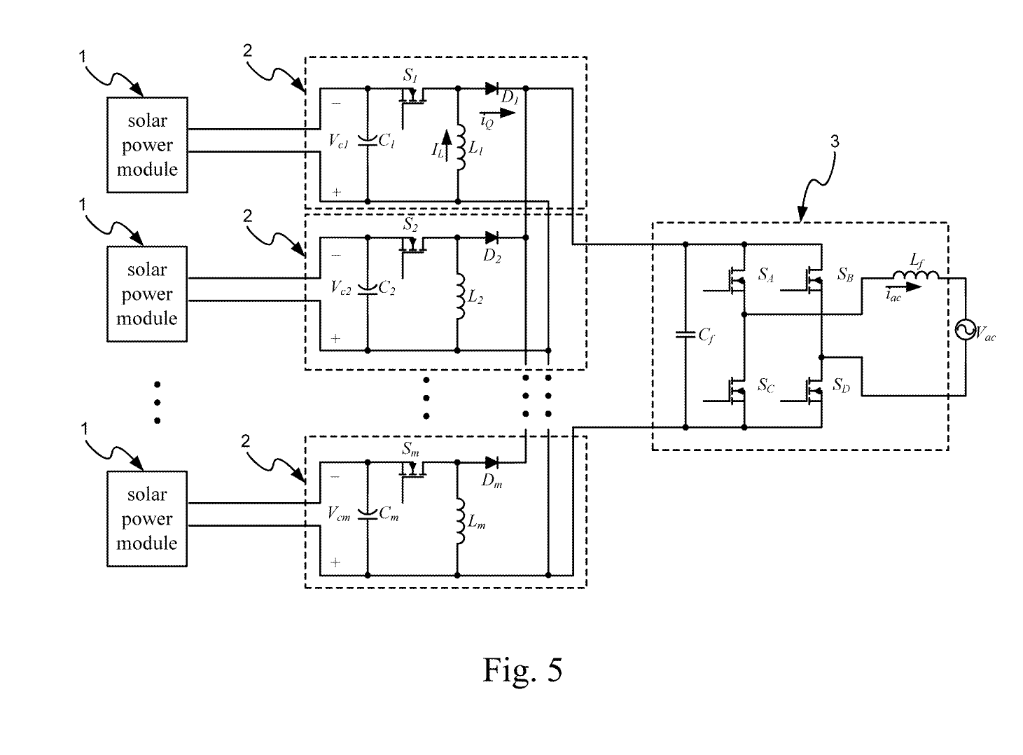

FIG. 5 is a schematic view of use status according to a second embodiment of the present invention. As shown, this invention can be realized in the manner of the second embodiment, in addition to the first embodiment. The difference between the two embodiments is in that the second embodiment can be realized in modular way. Specifically, a majority of solar power modules 1 is connected the MPPT power converter 2 respectively, and connected to the DC/AC filter 3. The alternative control of a command phase enables output filtering and efficiency better. This makes the present invention more in line with the need for actual use.

In summary, the household power parallel converter according to the present invention applied to the solar power generation system and having a maximum power tracking can effectively improve the shortcomings in the prior art. The DC/AC filter can be connected to the household grid in parallel. The solar power module is used to convert and output the solar energy in form of DC voltage. The MPPT power converter converts the DC into a high-frequency current which has the same phase as the household power, and also maximize the output power. Then the DC/AC filter is used to output to the household power a current which has the same phase as the grid. Thereby, a simplified structure which can increase the device expanding flexibility and have the maximum output performance for solar power generation can be achieved with lower cost. This makes the invention more progressive and more practical in use which complies with the patent law.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A household power parallel converter applied to a solar power generation system with maximum power tracking function, the converter comprising
a solar power module;
a MPPT power converter connected to the solar power module; and
a DC/AC filter connected to the MPPT power converter.

2. The converter of claim 1, wherein the solar power module comprises a majority of solar panels connected to one another in parallel.

3. The converter of claim 1, wherein the MPPT power converter comprises a capacitor connected to the solar power module, a switching element connected to the capacitor, a MPPT controller connected to the capacitor and the switching element, an inductor connected to the switching element and the inductor, and a diode connected to the inductor.

4. The converter of claim 1, wherein the DC/AC filter comprises a capacitor connected to the MPPT power converter, first, second, third and fourth switches respectively connected to the capacitor, and an inductor connected to the first, second, third and fourth switches.

5. The converter of claim 4, wherein the first, second, third and fourth switches are connected to one another.

6. The converter of claim 4, wherein the first, second, third and fourth switches are low-frequency switches.
